(19) United States
(12) Patent Application Publication
(10) Pub. No.: US 2022/0152853 A1
(43) Pub. Date: May 19, 2022

(54) SHAVING HEAD

(71) Applicant: BIC Violex S.A., Anoixi (GR)

(72) Inventor: Panagiotis MOUSTAKAS, Anoixi (GR)

(73) Assignee: BIC Violex S.A., Anoixi (GR)

(21) Appl. No.: 17/526,180

(22) Filed: Nov. 15, 2021

(30) Foreign Application Priority Data
Nov. 17, 2020 (EP) 20208191.5

(51) Int. Cl. B26B 21/22; B26B 21/40; B26B 21/52

(52) U.S. Cl. CPC B26B 21/225; B26B 21/4012; B26B 19/40; B26B 21/521; B26B 21/4037

(57) ABSTRACT

A razor cartridge comprises a housing, at least one first cutting member and at least one second cutting member. The at least one first cutting member and the at least one second cutting member are arranged in the housing. The at least one first cutting member is configured to shave in a first direction, and the at least one second cutting member is configured to shave in a second direction opposite to the first direction. A longitudinal support bar is arranged between the at least one first cutting member and the at least one second cutting member. The at least one first cutting member comprises a blade support including a top portion having an inner surface that, in use, faces away from a shaving plane and a blade attached to the inner surface of the top portion, wherein the blade includes a cutting edge.

### CROSS REFERENCE TO RELATED APPLICATION

This application claims benefit from European patent application EP20208191.5 filed on 17 Nov. 2020, its content being incorporated herein by reference.

### TECHNICAL FIELD

The present disclosure relates to the field of razor cartridges, in particular razor cartridges for providing multiple shaving directions.

### TECHNICAL BACKGROUND

A bifunctional razor cartridge comprising at least one movable blade facing in a first direction with at least one other blade facing in another direction, as well as an independently movable guard bar and a pivotable support is disclosed in WO 96/32232 A1.

The object of the present disclosure is to provide an alternative razor cartridge for providing multiple shaving directions. Another object of the present disclosure is to provide a razor cartridge for providing different shaving levels. A third object of the present disclosure is to provide a razor cartridge comprised of a combination of guard bar and comb-like guard bar.

### SUMMARY

The present disclosure relates to a razor cartridge as defined in claim 1. The dependent embodiments depict advantageous embodiments of the present disclosure.

A razor cartridge according to the present disclosure comprises at least one first cutting member and at least one second cutting member, wherein the at least one first cutting member and the at least one second cutting member are arranged in a housing. The at least one first cutting member is configured to shave in a first direction, whereas the at least one second cutting member is configured to shave in a second direction opposite to the first direction. A longitudinal support bar is arranged between the at least one first cutting member and the at least one second cutting member. The support bar may support the skin, increase fluidity as well as reduce the skin-bulging effect. The support bar may accommodate a lubricating strip, exfoliation features and/or other lubricative-hydrating elements. The at least one first cutting member comprises a blade support including a top portion having an inner surface that, in use, faces away from a shaving plane and a blade attached to the inner surface of the top portion, wherein the blade includes a cutting edge. Alternatively, the cutting members may be movable bent blades or bent blades.

The bidirectional razor cartridge described in the present disclosure may provide several benefits over common unidirectional razor cartridges, such as an improved shaving durability, a more economic production and a higher sustainability. As a shaving process involving the at least one first cutting member facing in a first direction does not wear down the at least one second cutting member facing in a second, opposite direction, more or less double the durability of a common unidirectional razor cartridge may be provided. Further, since the razor cartridge may be more durable than conventional unidirectional razor cartridges, a better sustainability may be achieved. When shaving, the blade support of the at least one first cutting member is brought into contact with the skin (shaving plane) in addition to the cutting edge of the blade. Therefore, the number of contact points between the razor cartridge and the skin is increased, up to being doubled. The amount of pressure exerted on a portion of skin by each cutting edge is significantly reduced, leading to fewer incidents of skin injury (“nicking”) and a more comfortable shave. The blade may be mounted on an inner surface of the blade support to enable the blade support to simultaneously contact the skin at the same time as the cutting edge of the blade, in use. This means that the portions of the blade support in contact with the skin reduce or minimize the “skin bulge”, thus reducing the risk of nicks and cuts occurring. Another effect is that durability of the blades is prolonged, since less pressure is applied to the skin thus resulting in a less aggressive shaving and therefore the blades wear at a lower rate.

A first bar may be arranged on a longitudinal side of the housing extending parallel to the at least one first cutting member such that the at least one first cutting member is arranged between the first bar and the support bar, and a second bar may be arranged on a longitudinal side of the housing extending parallel to the at least one second cutting member such that the at least one second cutting member is arranged between the second bar and the support bar. Therefore, the first shaving direction of the at least one first cutting member may face towards the first bar, and the second shaving direction of the at least one second cutting member may face towards the second bar.

The at least one second cutting member may comprise a blade support including a top portion having an inner surface that, in use, faces away from the shaving plane and a blade attached to the inner surface of the top portion, wherein the blade may include a cutting edge.

The at least one first cutting member and the at least one second cutting member may be configured to shave within the same shaving plane, wherein the shaving plane is defined by the highest contact points or contact lines of the first bar and of the second bar, respectively, when the housing is arranged in a horizontal position with the first and second cutting members on the top side of the housing. The cutting edges of the first and second cutting members may be arranged higher than the shaving plane, in particular 0.01 to 0.30 mm above the shaving plane. A bidirectional razor cartridge according to the present disclosure may provide the same shaving process on each side of the razor cartridge, and therefore provides a longer shaving durability, as the shaving process in a first direction does not wear down the cutting member facing in the opposite direction.

On the other hand, the cutting edge of the at least one first cutting member or cutting edges of the first cutting members may be arranged higher than the shaving plane, in particular 0.01 to 0.30 mm above the shaving plane. In embodiments, the cutting edge of the at least one first cutting member or cutting edges of the first cutting members may be arranged 0.01 to 0.10 mm, or 0.05 to 0.15 mm above the shaving plane. The cutting edge of the at least one second cutting member or the cutting edges of the second cutting members may be arranged within the shaving plane or below the shaving plane, in particular 0.01 to 0.30 mm below the shaving plane. In embodiments, the cutting edge 14b of the at least one second cutting member or the cutting edges of the second cutting members may be arranged 0.01 to 0.10 mm, or 0.05 to 0.15 mm below the shaving plane. The highest contact line of the support bar may be arranged within the shaving plane, or up to 0.3 mm above the shaving plane, or up to 0.3 mm below the shaving plane.

The support bar may comprise first and second surfaces on different heights for defining two different first and second shaving planes. The first surface of the support bar may face the at least one first cutting member, and the first shaving plane may be defined by the highest contact points or contact line of the first bar and by the first surface of the support bar when the housing is arranged in a horizontal position with the at least one first and second cutting members on the top side of the housing. The second surface of the support bar may face the at least one second cutting member, and the second shaving plane may be defined by the highest contact points or contact line of the second bar and by the second surface of the support bar when the housing is arranged in a horizontal position with the at least one first and second cutting members on the top side of the housing.

The cutting edge of the at least one first cutting member or the cutting edges of the first cutting members may be arranged higher than the first shaving plane, in particular 0.01 to 0.30 mm above the first shaving plane, whereas the cutting edge of the at least one second cutting member or the cutting edges of the second cutting members may be arranged within the second shaving plane or below the second shaving plane, in particular 0.01 to 0.30 mm below the second shaving plane. The first surface of the support bar may be arranged 0.01 to 0.40 mm below the second surface of the support bar when the housing is arranged in a horizontal position with the first and second cutting members on the top side of the housing.

A bidirectional razor cartridge providing different shaving levels for each cutting member, such as at least one first cutting member facing in a first direction may provide a more sensitive shaving process, whereas the at least one second cutting member facing in the opposite direction may provide a more efficient-aggressive shaving process. Further, the longitudinal support bar may comprise at least two lubricating strips, which may differ in terms of composition, shape and/or color. The colors of the lubricants may indicate the position of the cutting edge and/or may indicate the wear condition of the cutting members, such that the user may identify which cutting member has already been used. In addition, indicators, such as engraved signs or arrows, projections, stickers or any other distinguishing features may be included, to further indicate the position of the cutting edge of the cutting members.

One of the first and second bars may be designed as a guard bar, or both first and second bars may be designed as guard bars. A guard bar may be a longitudinal strip of rubber with a longitudinally grooved or ridged surface, in particular with longitudinal grooves or ridges with a depth of 0.1 to 2 mm, more precisely 0.2 to 1.5 mm. The depth of the longitudinal grooves or ridges may decrease towards a first and/or second longitudinal outer edge of the housing. The guard bar may be made of a soft rubber material having shore hardness of 1 to 70 A, more precisely 20 to 60 A, and supports the skin, as well as reduces skin-bulging effects.

Alternatively, one of the first and second bars may be designed as a comb-like bar, or both first and second bars may be designed as comb-like bars. A comb-like bar may comprise a plurality of transverse grooves or ridges, with a depth of 0.1 to 5 mm, in particular with a depth of 0.2 to 4 mm, and may comprise an outer contour that decreases towards the first and/or second longitudinal outer edge of the housing. The comb-like bar may be made of a hard plastic material having shore hardness of 40 to 99 A, more precisely 50 to 80 A. The razor cartridge may be designed as a trimmer, wherein the comb-like bar is designed to lead the hair to the cutting edge of the cutting members. A razor cartridge comprised of a guard bar and a comb-like bar may provide a shaving process for at least one first cutting member facing in the direction of the guard bar, and a trimming process for the at least one second cutting member facing in the direction of the comb-like guard bar, opposite to the first direction.

Furthermore, a razor is provided which comprises a razor handle and a razor cartridge as defined above, wherein the razor cartridge is coupled to the razor handle. In embodiments, the razor cartridge may be releasably attached to the razor handle via a pivotable or non-pivotable coupling, integrally formed with the razor handle via a non-pivotable coupling, or integrally formed with the razor handle via a pivotable coupling.

### BRIEF DESCRIPTION OF THE DRAWINGS

Additional details and features of the disclosure are described with reference to the following figures in which

FIG. 1a shows a first embodiment of a razor cartridge according to the present disclosure with a combination of guard bar and comb-like bar;

FIG. 1b shows the rear view of an embodiment of a razor cartridge according to the present disclosure with a combination of guard bar and comb-like bar;

FIG. 1c shows the side view of an embodiment of a razor cartridge according to the present disclosure with a combination of guard bar and comb-like bar;

FIG. 1d shows a perspective CAD embodiment of the present disclosure with a combination of guard bar and comb-like bar;

FIG. 2a shows another embodiment of a razor cartridge according to the present disclosure comprised of two guard bars;

FIG. 2b shows the rear view of an embodiment of a razor cartridge according to the present disclosure comprised of two guard bars;

FIG. 2c shows a perspective CAD embodiment of the present disclosure comprised of two guard bars;

FIG. 3a shows another embodiment of a razor cartridge according to the present disclosure comprised of two comb-like bars;

FIG. 3b shows the rear view of another embodiment of a razor cartridge according to the present disclosure comprised of two comb-like bars;

FIG. 3c shows the side view of another embodiment of a razor cartridge according to the present disclosure comprised of two comb-like bars;

FIG. 3d shows a perspective CAD embodiment of a razor cartridge according to the present disclosure comprised of two comb-like bars;

FIG. 4 shows a more detailed front view of another embodiment of a razor cartridge according to the present disclosure comprised of two comb-like bars;

FIG. 5a shows the side view of another embodiment of a razor cartridge comprising a single shaving plane according to the present disclosure;

FIG. 5b shows the side view of another embodiment of a razor cartridge comprising two different shaving planes according to the present disclosure;

FIG. 6 is a schematic side view of a cutting member comprising a blade disposed on an inner surface of a blade support.

### DETAILED DESCRIPTION

Embodiments of the razor cartridge according to the present disclosure will be described with reference to the figures as follows.

Throughout the description the terms height and highest contact points refer to a position of the cartridge, in which the housing 1 of the disclosed razor cartridge is arranged in a horizontal position with the first and second cutting members 6 and 7 on the top side of the housing 1, and wherein a shaving plane 15 or the shaving planes 15a, 15b as discussed below are arranged horizontally. Typically, the shaving plane is defined as the tangential line intersecting the first and second skin contact points of, for example, cutting edges of the razor cartridge. More simply, the shaving plane may be approximated as a line between the highest points on the skin-contacting surface of the razor cartridge. During a shaving operation, movement of a razor handle causes the cutting members of the razor cartridge to be moved across the shaving plane in the shaving direction, enabling the cutting members to remove unwanted hair.

In the following specification, the term “cutting member” means a component of a razor cartridge that, in use, contacts the skin of a user and cuts protruding hairs. A cutting member can be a razor blade having a blade with a cutting edge glued, or laser welded, to a separate bent support member. The bent support member can be fitted into a cutting member support slot in-between two opposed cutting member guides, such as protrusions from a transverse frame member of the razor cartridge. The blade can be attached to the face of the bent support member that faces towards a user of the razor cartridge, in use. Alternatively, the blade can be attached to the face of the bent support member that faces away from a user of the razor cartridge, in use. In this latter case, each cutting member has two contact points with the skin of the user (the blade edge, and the distal end of the bent support member), to thus reduce pressure on the user's skin. Alternatively, the cutting member may be a “bent blade”. This is an integrally formed cutting member comprising a radiused bend, and a cutting edge formed at a distal end of the radiused bend. A movable cutting member or a movable bent blade may be a cutting member which is movable in the housing, more specifically in the cutting member support slot, in a direction perpendicular to the shaving plane. The movable cutting member may be biased by at least one biasing element which is configured to exert a biasing force on the respective cutting member towards the shaving plane, wherein the cutting member is in a rest position. In embodiments, the at least one biasing element may be a plurality of resilient fingers. In the rest position, the cutting edges of the cutting members may bear against a corresponding stop portion.

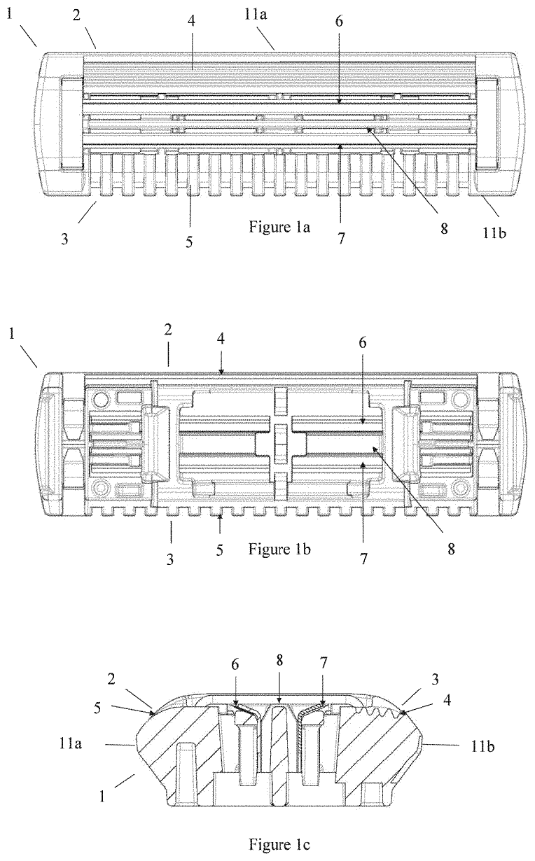

FIG. 1a to FIG. 1d show a first embodiment of a razor cartridge according to the present disclosure with a combination of a guard bar 4 and a comb-like bar 5. The razor cartridge comprises at least one first cutting member 6 and at least one second cutting member 7, wherein the at least one first cutting member 6 and the at least one second cutting member 7 are arranged in a housing 1. The at least one first cutting member 6 is configured to shave in a first direction, and the at least one second cutting member 7 is configured to shave in a second direction opposite to the first direction. A longitudinal support bar 8 may be arranged between the at least one first cutting member 6 and the at least one second cutting member 7 and may support the skin, reduce skin-bulging effects, and increase fluidity. The housing 1 comprises a first longitudinal outer edge 11a extending parallel to and proximate the at least one first cutting member 6 and a second longitudinal outer edge 11b extending parallel to and proximate the at least one second cutting member 7. The support bar 8 may comprise a width of 0.1 to 8 mm, specifically 0.5 to 4 mm, and further may accommodate a lubricating strip, exfoliation features or any other lubricative-hydrating elements. The cutting members 6 and 7, more precisely cutting blades may be selected from the group comprising movable blades with support, movable bent blades, and/or bent blades.

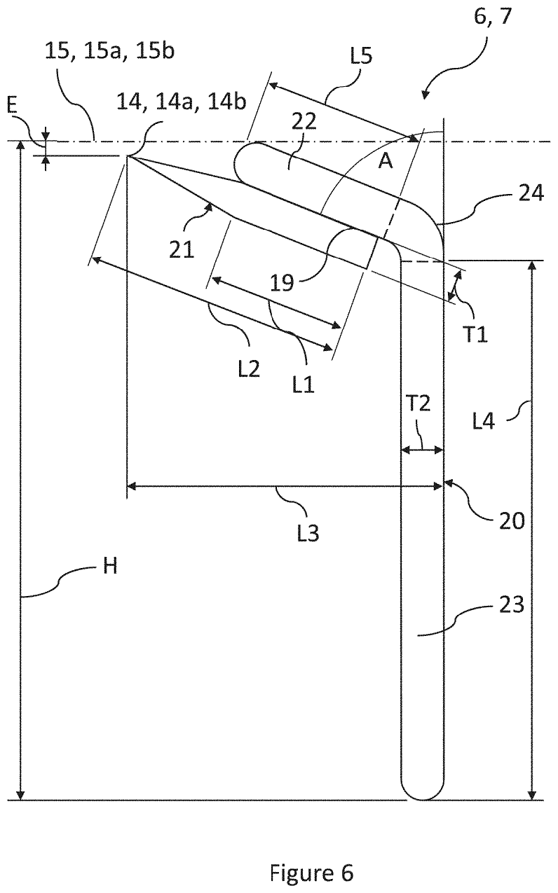

FIG. 6 is a schematic side view of an embodiment of the at least one first cutting member 6 and/or the at least one second cutting member 7 according to the present disclosure. As shown in FIG. 6, the at least one of the first and/or second cutting members 6, 7 is a sub-assembly comprising a longitudinal blade 21 mounted on a longitudinal blade support 20. The longitudinal blade support 20 comprises a substantially elongated lower portion 23, more specifically a flat lower portion 23, which is suitable for being held in at least one holding slot of the housing 1 of the razor cartridge, a substantially elongated top portion 22, more specifically a flat top portion 22, and a radius bend portion 24. The bend portion 24 is arranged between the lower portion 23 and the top portion 22, and defines an angle of approach A of the blade 21 with respect to the shaving plane 15. The top portion 22 comprises an inner surface 19. The approach angle A defines the angle of declination of an inner surface 19 of the top portion 22 from the reference of the blade support 20 (more specifically, of the lower portion 23). In an example, A is an acute angle, specifically between 60 and 75 degrees, more specifically between 65 and 70 degrees, in particular 68 degrees. The blade 20 is mounted on the inner surface 19 of the blade support 20, more specifically of the top portion 22. The radius bend portion 24 may have an inner radius of curvature RI of at least 0.1 mm. The radius bend portion 24 may have an inner radius of curvature RI that is less than 0.9 mm. A minimum recommended inner radius of curvature RI of sheet metal should be at least the same as its thickness T2. A safety factor of the thickness of the blade support 20 may be applied. By multiplying the safety factor with the thickness of T2, the inner radius of curvature RI may be approximately between 0.15 mm and 0.30 mm, more specifically between 0.18 mm and 0.25 mm, and in particular between 0.19 mm and 0.21 mm. The radius bend portion 24 may have an outer radius of curvature RO, which may be approximately between 0.20 mm and 0.50 mm, more specifically between 0.30 mm and 0.40 mm, and in particular between 0.34 mm and 0.36 mm.

Thereby, the at least one first cutting member 6 comprises a blade support 20 including the top portion 22 having an inner surface 19 that, in use, faces away from the shaving plane 15 and a blade 21 attached to the inner surface 19 of the top portion 22. In other words, the blade 21 may be mounted “underneath the blade support 20”. The phrase “underneath the blade support” for the purposes of this specification means a side of the blade support 20 that is furthest from a shaving plane (skin) of a user when the razor cartridge is in use. The blade 21 includes a cutting edge 14a. Additionally or alternatively, the at least one second cutting member 7 may comprise a blade support 20 including a top portion 22 having an inner surface 19 that, in use, faces away from the shaving plane 15 and a blade 21 attached to the inner surface 19 of the top portion 22. The blade 21 includes cutting edge 14b. In embodiments, one, two, three, four, five, six, seven or more first cutting members 6 and/or second cutting members 7 may be provided. If a plurality of first and/or second cutting members 6, 7 are provided, one or more of the first and/or second cutting members 6, 7 may comprise the blade support 20 including the top portion 22 having an inner surface 19 that, in use, faces away from the shaving plane 15 and a blade 21 attached to the inner surface 19 of the top portion 22, as described above. In embodiments, each of the first and/or second cutting members 6, 7 may comprise the blade support 20 including the top portion 22 having an inner surface 19 that, in use, faces away from the shaving plane 15 and a blade 21 attached to the inner surface 19 of the top portion 22, as described above.

In an embodiment, the razor cartridge may comprise at least two first cutting members 6 oriented (and/or configured to shave) in the first direction, and at least two second cutting members 7 oriented (and/or configured to shave) in the second direction opposite the first direction. In each direction, when viewed from a geometrical center (or the supporting bar 8) of the razor cartridge, the first cutting member of the at least two first cutting members 6 and the first cutting member of the at least two second cutting members 7 may be fixed to the housing 1, more specifically fixedly arranged in respective cutting member support slots. In other words, these cutting members may not be movable in the housing 1. However, all further cutting members, e.g. the second cutting member of the least two first cutting members 6, may be movable within the housing 1, more specifically in the respective cutting member support slot. In this way, the blade support 20 of the respective cutting member which is not used for shaving (or in other words, wherein the razor cartridge is moved in the opposite direction) can function as an additional guard bar. This can lead to increased skin protection during shaving.

The inner surface 19 may be a bottom surface of the blade support 20, or in other words, a surface of the blade support 20 which is opposite the top (in particular a top side) of the blade support 20, more specifically of the top portion 22. The phrase “top of the blade support” for the purposes of this specification means a side of a blade support 20 of a razor cartridge that is closest to a shaving plane 15 (and/or skin) of a user when the razor cartridge is in use.

The blade support 20 may be made from a flat sheet metal part which is bent before welding of the blade 21 on the inner surface 19 of the blade support 20 at the top portion 22. The flat sheet metal part may derive from a metal wire which has been flattened i.e. by rolling process. The lower portion 23 may have a length L4 of at least 1.0 mm. In embodiments, the length L4 may be between 1.1 mm and 1.8 mm, more specifically between 1.20 mm and 1.40 mm, in particular between 1.20 mm and 1.25 mm. The top portion 22 may have a length L5 of at least 0.50 mm. In embodiments, the length L5 may be between 0.50 mm and 0.90 mm, more specifically between 0.60 mm and 0.85 mm, in particular between 0.74 mm and 0.80 mm. The at least one first cutting member 6 and/or the at least one second cutting member 7 thus comprise a blade 21 (razor blade). The blade 21 has a flat connection portion with a thickness T1, which can be about 0.1 mm (for example, between 0.04 and 0.11 mm). In embodiments, the thickness T1 may be between 0.06 mm and 0.09 mm, more specifically between 0.07 mm and 0.08 mm. The total length L2 of the blade 21 between the cutting edge 14a, 14b of the blade 21 and an opposite back edge of the blade 21 can be about 1 mm (for example, between 0.8 mm and 1.3 mm). In embodiments, the total length L2 of the blade 21 may be between 0.90 mm and 1.20 mm, more specifically between 1.06 mm and 1.16 mm. The flat connection portion of the blade 21 that is in contact with the inner surface 19 of the top portion 22 of the blade support 20 that, in use, faces away from the shaving plane 15 can have a length L1 that is about 0.49 mm+/−0.1 mm long. However, in embodiments, the length L1 can be between 0.30 mm and 0.90 mm, more specifically between 0.40 mm and 0.70 mm. The distance between the cutting edge 14, 14a, 14b and a rounded edge of the top portion 22 may be about 0.3 mm, measured parallel to the blade 21, more specifically to the connection portion. In this way, a good retention of the blade on the underside of the blade support 20 (the inner surface 19 of the blade support) is ensured.

In an example, a height H of the at least one first and/or second cutting member 6, 7 can be between 1.50 mm and 2.70 mm, more specifically between 1.75 mm and 2.00 mm, in particular between 1.84 mm and 1.92 mm. In other embodiments, the height H may be between 2.53 mm and 2.63 mm, particularly about 2.58 mm. In an example, a front end of the blade support 20 may be rounded or chamfered to improve gliding properties of the cutting members 6, 7. In an example, the blade 21 may be positioned on the inner surface 19 of the blade support 20 to adjust an exposure E of the cutting edge 14a, 14b positively or negatively compared to the shaving plane 15. The exposure is a measure of how prominently the cutting edge 14a, 14b of a blade protrudes above or sinks below the end of its blade support 20. In an example, the blade 21 may be positioned to have an exposure E relative to the shaving plane 15 in the range of −80 μm to +80 μm, specifically an exposure of about −75 μm, −65 μm, −60 μm, −55 μm, −50 μm, −45 μm, −40 μm, −35 μm, −30 μm, −25 μm, −20 μm, −15 μm, −10 μm, −5 μm, 0 μm, 5 μm, 10 μm, 15 μm, 20 μm, 25 μm, 30 μm, 35 μm, 40 μm, 45 μm, 50 μm, 55 μm, 60 μm, 65 μm, 70 μm, or 75 μm. A length L3 of the at least one first and/or second cutting member 6, 7, measured between the cutting edge 14a, 14b and an outer face of the lower portion 23 of the blade support 20 may be about 1.0 mm (for example, between 0.9 mm and 1.6 mm). The blade 21 is fixed on the inner surface 19 of the blade support 20 by any known means, such as by laser spot welding. In examples, the blade 21 is fixed on the inner surface 19 of the blade support 20 by a plurality of spot welds (for example, between ten and sixteen spot welds) distributed along the longitudinal dimension of the blade support 20. Each of the spot welds may be performed on the inner face of the blade. Alternatively, each of the spot welds may be carried out on the outer surface of the blade support 20, or a mixture of the two.

The bidirectional razor cartridge described in the present disclosure may provide several benefits over common unidirectional razor cartridges, such as an improved shaving durability, more economic production, and better sustainability. As a shaving process involving the at least one first cutting member 6 facing in a first direction does not wear down the at least one second cutting member 7 facing in a second, opposite direction, more or less double the durability of a common unidirectional razor cartridge may be provided. A razor cartridge according to the present disclosure may be used for the double number of shaving processes compared to a conventional unidirectional shaving cartridge, and therefore may be more economic in terms of price-performance ratio. Further, since the razor cartridge may be more durable than conventional unidirectional razor cartridges, a better sustainability may be achieved. When shaving, the blade support(s) of the cutting members are brought into contact with the skin (shaving plane) in addition to the cutting edges of the blade. Therefore, the number of contact points between the razor cartridge and the skin is increased, up to being doubled. The amount of pressure exerted on a portion of skin by each cutting edge is significantly reduced, leading to fewer incidents of skin injury (“nicking”) and a more comfortable shave. The blade 21 is mounted on an inner surface 19 of the blade support 20 to enable the blade support 20 to simultaneously contact the skin at the same time as the cutting edge of the blade, in use. This means that the portions of the blade support 20 in contact with the skin reduce or minimize the “skin bulge”, thus reducing the risk of nicks and cuts occurring. Another effect is that durability of the blades is prolonged, since less pressure is applied to the skin thus resulting in a less aggressive shaving and therefore the blades wear at a lower rate.

FIG. 1a shows a front view of an embodiment of a razor cartridge, wherein a first bar 2 is arranged on a longitudinal side of the housing 1 extending parallel to the at least one first cutting member 6 such that the at least one first cutting member 6 is arranged between the first bar 2 and the support bar 8, and a second bar 3 is arranged on a longitudinal side of the housing 1 extending parallel to the at least one second cutting member 7 such that the at least one second cutting member 7 is arranged between the second bar 3 and the support bar 8. Therefore, the first shaving direction of the at least one first cutting member 6 is facing towards the first bar 2, and the second shaving direction of the at least one second cutting member 7 is facing towards the second bar 3. Alternatively, both the at least one first cutting member 6 and the at least one second cutting member 7 may face towards the support bar 8.

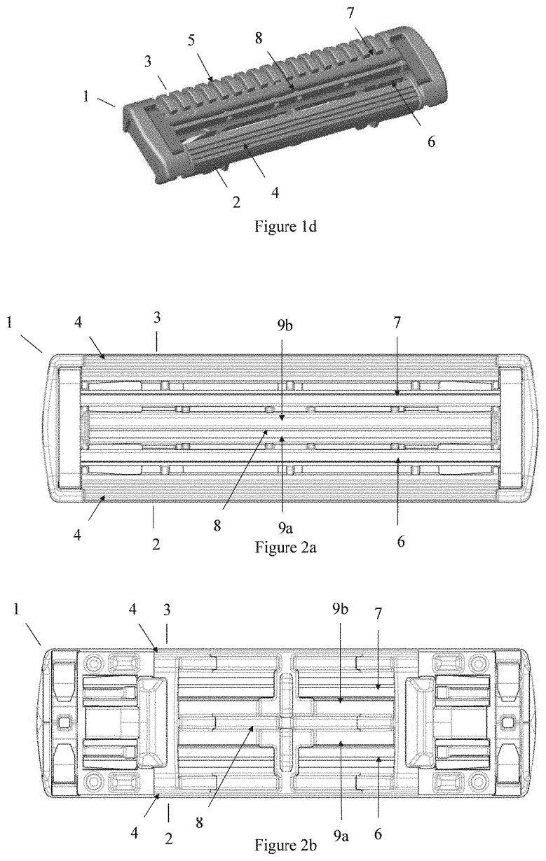

FIG. 2a to FIG. 2c show an embodiment of a razor cartridge according to the present disclosure comprising of two guard bars 4. One of the first and second bars 2 and 3 may be designed as a guard bar 4, or both first and second bars 2 and 3 may be designed as guard bars 4. A guard bar 4 may be a longitudinal strip of rubber with a longitudinally grooved or ridged surface, in particular with longitudinal grooves or ridges with a depth of 0.1 to 2 mm, more precisely 0.2 to 1.5 mm. As viewed from the support bar 8, the depth of the longitudinal grooves or ridges may decrease towards the longitudinal outer edge 11a, 11b of the housing 1. Alternatively, the depth of the longitudinal grooves or ridges may be constant or may increase towards the longitudinal outer edge 11a, 11 b of the housing 1. As best shown in FIG. 1c, the guard bar 4 may have an outer contour that tapers and/or is rounded from a position proximate the support bar 8 towards the first and/or second longitudinal outer edge 11a, 11b. In a cross-section, the longitudinal grooves or ridges may have a tapered and/or rounded shape extending from the outer contour into the guard bar 4. A width of the grooves or ridges may decrease extending from the outer contour into the guard bar. The guard bar 4 may be made of a soft rubber material having shore hardness of 1 to 70 A, more precisely 20 to 60 A, and supports the skin, reduces skin-bulging effects and increases fluidity, thus improves the shaving process.

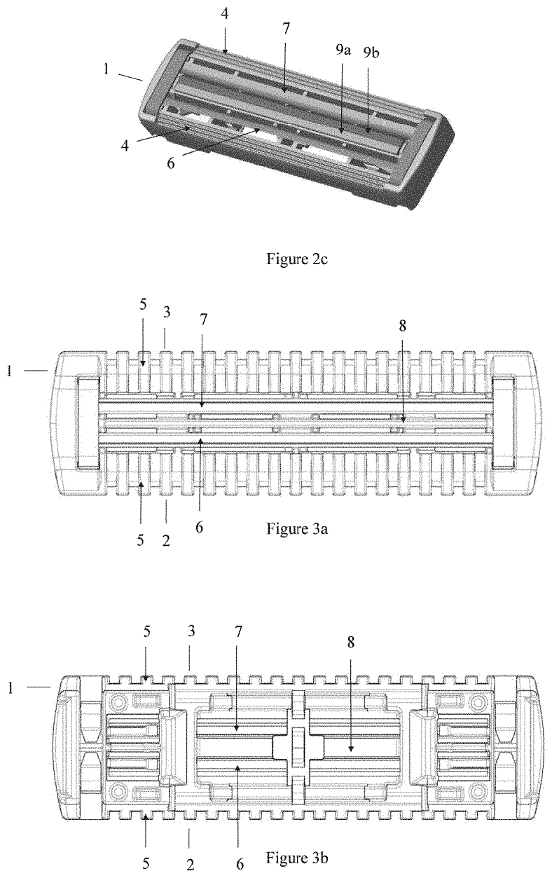

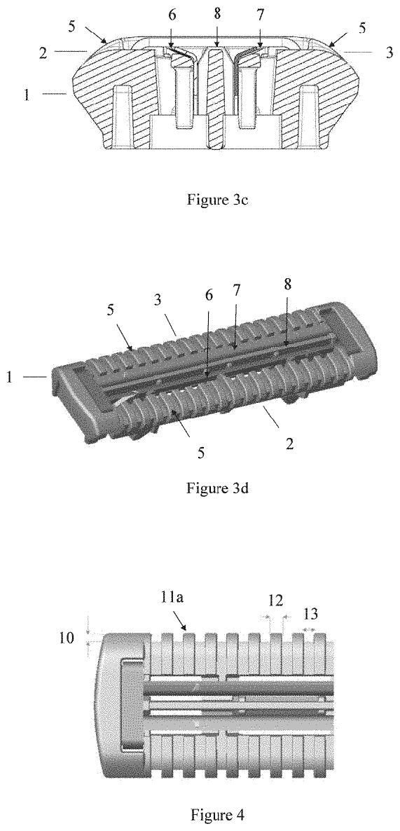

FIG. 3a to FIG. 3d shows an embodiment of a razor cartridge according to the present disclosure comprised of two comb-like bars 5. One of the first and second bars 2 and 3 may be designed as a comb-like bar 5, or both first and second bars 2 and 3 may be designed as comb-like bars 5. FIG. 4 shows a more detailed embodiment of a razor cartridge comprising two comb-like bars 5. A comb-like bar 5 may comprise a plurality of transverse grooves or ridges, with a depth 10 of 0.1 to 2 mm, in particular with a depth 10 of 0.2 to 1.5 mm. As viewed from the support bar, the depth of the transverse grooves or ridges may decrease towards the first and/or second longitudinal outer edge 11a, 11b of the housing 1. Alternatively, the depth of the longitudinal grooves or ridges may be constant or may increase towards the longitudinal outer edge 11a, 11b of the housing 1. An outer contour of the comb-like bar 5 may be tapered and/or rounded from a position proximate the support bar 8 towards the first and/or second longitudinal outer edge 11a, 11b of the housing 1. The transverse grooves or ridges may comprise a width 12 of 0.4 to 6 mm, more precisely 1 to 3 mm, and are placed at a distance 13 of 0.5 to 10 mm, more precisely 1 to 4 mm. The comb-like bar may be made of a polymeric material, more specifically a hard plastic material, having shore hardness of 40 to 99 A, more precisely 50 to 80 A.

The razor cartridge may be designed to operate as a trimmer, wherein the comb-like bar 5 may be designed to lead the hair to the cutting edge of the cutting members 6 and 7. A razor cartridge comprised of a combination of guard bar 4 and comb-like bar 5 may provide a shaving process for the at least one first cutting member 6 facing in the direction of the guard bar 4, and a trimming process for the at least one second cutting member 7 facing in the direction of the comb-like bar 5, opposite to the first direction, as shown in FIG. 1a.

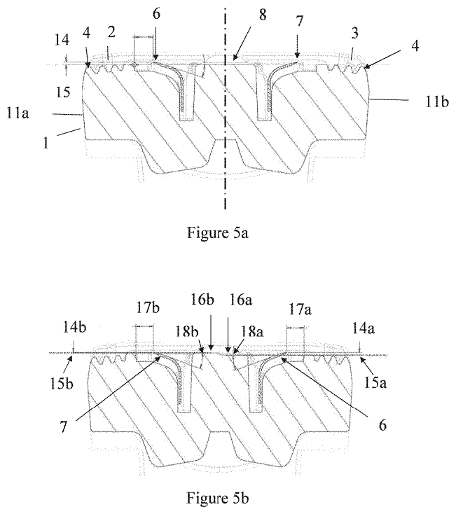

FIG. 5a shows an embodiment of a razor cartridge according to the present disclosure, in which the first and second cutting members 6 and 7 may be configured to shave within the same shaving plane 15. The shaving plane 15 is defined by the highest contact points or contact lines of the first bar 2 and of the second bar 3, respectively, when the housing 1 is arranged in a horizontal position with the first 6 and second cutting members 7 on the top side of the housing 1. The cutting edges 14 of the first and second cutting members 6, 7 are arranged higher than the shaving plane 15, in particular 0.01 to 0.30 mm above the shaving plane 15. This embodiment discloses a bidirectional razor cartridge, which may provide the same shaving process on each side of the razor cartridge, and therefore may provide a longer shaving durability, as the shaving process in a first direction may not wear down the cutting member facing in the opposite direction.

FIG. 5b shows an embodiment of a razor cartridge according to the present disclosure, in which the cutting edge 14a of the least one first cutting member 6 or cutting edges of the first cutting members 6 may be arranged higher than the shaving plane 15, in particular 0.01 to 0.30 mm above the shaving plane 15, and the cutting edge 14b of the at least one second cutting member 7 or the cutting edges 14b of the second cutting members 7 may be arranged within the shaving plane 15 or below the shaving plane 15, in particular 0.01 to 0.30 mm below the shaving plane 15. In embodiments, the cutting edge 14a of the at least one first cutting member 6 or cutting edges of the first cutting members 6 may be arranged 0.01 to 0.10 mm, or 0.05 to 0.15 mm above the shaving plane 15. In embodiments, the cutting edge 14b of the at least one second cutting member 7 or the cutting edges of the second cutting members 7 may be arranged 0.01 to 0.10 mm, or 0.05 to 0.15 mm below the shaving plane 15. The highest contact line of the support bar 8 may be arranged within the shaving plane 15, or up to 0.3 mm above the shaving plane 15, or up to 0.3 mm below the shaving plane 15.

The support bar 8 may comprise first and second surfaces 16a and 16b on different heights for defining two different first and second shaving planes 15a and 15b, as shown in FIG. 5b. The first surface 16a of the support bar 8 is facing the at least one first cutting member 6, and the first shaving plane 15a is defined by the highest contact points or contact line of the first bar 2 and by the first surface 16a of the support bar 8, when the housing 1 is arranged in a horizontal position with the first and second cutting members 6, 7 on the top side of the housing 1. The second surface 16b of the support bar 8 is facing the at least one second cutting member 7, and the second shaving plane 15b is defined by the highest contact points or contact line of the second bar 3 and by the second surface 16b of the support bar 8, when the housing 1 is arranged in a horizontal position with the first and second cutting members 6, 7 on the top side of the housing 1.

The cutting edge 14a of the at least one first cutting member 6 or cutting edges 14a of the first cutting members 6 may be arranged higher than the first shaving plane 15a, in particular 0.1 to 0.5 mm above the first shaving plane 15a. The cutting edge 14b of the at least one second cutting member 7 or the cutting edges 14b of the second cutting members 7 may be arranged within the second shaving plane 15b or below the second shaving plane 15b, in particular 0.01 to 0.30 mm below the shaving plane 15b. The first surface 16a of the support bar 8 may be arranged 0.01 to 0.40 mm below the second surface 16b of the support bar 8, when the housing 1 is arranged in a horizontal position with the first and second cutting members 6, 7 on the top side of the housing 1. The distance 17a of the cutting edge 14a of the at least one first cutting member 6 to the first ridge of first guard or comb-like bar may vary from the distance 17b of the cutting edge 14b of the at least one second cutting member 7 to the first ridge of the second guard or comb-like bar, but may be selected in a range of 0.5 to 20 mm, more precisely 2 to 10 mm. The angles 18a and 18b, defined as the angles of the flat upper surface of the cutting members to the respective shaving plane may as well differ from each other, but may be determined at a range of 17.5 to 26.5°.

A bidirectional razor cartridge according to the previous disclosure may provide different positions of the cutting edges 14a, 14b for the at least one first cutting member 6 facing in a first direction, and the at least one second cutting member 7 facing in a second direction, such that the at least one first cutting member 6 facing in the first direction provides a more sensitive shaving process, whereas the at least one second cutting member 7 facing in the second direction opposite the first direction provides a more efficient-aggressive shaving process. As shown in FIGS. 2a to 2c, the longitudinal support bar may comprise at least two lubricating strips 9a and 9b, which may differ in terms of composition, shape and/or color. The colors of the lubricants may indicate the position of the at least one first and second cutting members 6, 7 and/or may indicate the wear condition of the blades 21, such that the user can identify which blade 21 has already been used. In addition, indicators, such as engraved signs or arrows, projections, stickers, or any other distinguishing features may be included to further indicate the shaving levels of the at least one first and second cutting members 6, 7.

The razor cartridge may be manufactured by conventional methods in a high manufacturing production rate by using a linear assembly machine with high speed rates. A razor assembly may be provided comprising a razor cartridge holder comprising a plurality of razor cartridges and optionally a razor handle. Furthermore, in accordance with the present disclosure, a razor may be provided comprising a razor cartridge as defined above and a razor handle, wherein the razor cartridge is coupled to the razor handle. The razor cartridge according to the present disclosure may be releasably attached to the razor handle via a pivotable or non-pivotable connection, integrally formed with the razor handle via a non-pivotable connection, or integrally formed with the razor handle via a pivotable connection.

1. A razor cartridge, comprising:
a housing,
at least one first cutting member and at least one second cutting member, wherein the at least one first cutting member and the at least one second cutting member are arranged in the housing,
wherein the at least one first cutting member is configured to shave in a first direction, and the at least one second cutting member is configured to shave in a second direction opposite to the first direction, and
wherein a longitudinal support bar is arranged between the at least one first cutting member and the at least one second cutting member, and
wherein the at least one first cutting member comprises a blade support including a top portion having an inner surface that, in use, faces away from a shaving plane and a blade attached to the inner surface of the top portion, wherein the blade includes a cutting edge.

2. The razor cartridge according to claim 1, wherein a first bar is arranged on a longitudinal side of the housing extending parallel to the at least one first cutting member such that the at least one first cutting member is arranged between the first bar and the support bar, and
wherein a second bar is arranged on a longitudinal side of the housing extending parallel to the at least one second cutting member such that the at least one second cutting member is arranged between the second bar and the support bar.

3. The razor cartridge according to claim 2, wherein the first shaving direction of the at least one first cutting member is facing towards the first bar, and the second shaving direction of the at least one second cutting member is facing towards the second bar.

4. The razor cartridge according to claim 1, wherein the at least one second cutting member comprises a blade support including a top portion having an inner surface that, in use, faces away from the shaving plane and a blade attached to the inner surface of the top portion, wherein the blade includes a cutting edge.

5. The razor cartridge according to claim 2, wherein the at least one first cutting member and the at least one second cutting member are configured to shave within the same shaving plane, wherein the shaving plane is defined by the highest contact points or contact lines of the first bar and of the second bar, respectively, when the housing is arranged in a horizontal position with the first and second cutting members on the top side of the housing.

6. The razor cartridge according to claim 1, wherein the cutting edge of the at least one first cutting member or cutting edges of the at least one first and at least one second cutting members are arranged higher than the shaving plane, in particular 0.01 to 0.30 mm above the shaving plane.

7. The razor cartridge according to claim 1, wherein a highest contact line of the support bar is arranged within the shaving plane, or up to 0.3 mm above the shaving plane, or up to 0.3 mm below the shaving plane.

8. The razor cartridge according to claim 1, wherein the support bar has first and second surfaces on different heights for defining two different first and second shaving planes.

9. The razor cartridge according to claim 8, wherein the first surface of the support bar is facing the at least one first cutting member, and wherein the first shaving plane is defined by the highest contact points or contact line of the first bar and by the first surface of the support bar when the housing is arranged in a horizontal position with the first and second cutting members on the top side of the housing, and wherein the second surface of the support bar is facing the at least one second cutting member, and wherein the second shaving plane is defined by the highest contact points or contact line of the second bar and by the second surface of the support bar when the housing is arranged in a horizontal position with the first and second cutting members on the top side of the housing.

10. The razor cartridge according to claim 8, wherein the cutting edge of the at least one first cutting member or cutting edges of the first cutting members are arranged higher than the first shaving plane, in particular 0.01 to 0.30 mm above the first shaving plane, and wherein the cutting edge of the least one second cutting member or the cutting edges of the second cutting members are arranged within the second shaving plane or below the second shaving plane, in particular 0.01 to 0.30 mm below the second shaving plane.

11. The razor cartridge according to claim 8, wherein the first surface of the support bar is arranged 0.10 to 0.40 mm below the second surface of the support bar when the housing is arranged in a horizontal position with the first and second cutting members on the top side of the housing.

12. The razor cartridge according to claim 2, wherein one of the first and second bars is designed as a guard bar, or both first and second bars are designed as guard bars.

13. The razor cartridge according to claim 12, wherein the guard bar is a longitudinal strip of rubber with a longitudinally grooved or ridged surface, in particular with longitudinal grooves or ridges with a depth of 0.1 to 2 mm.

14. The razor cartridge according to claim 13, wherein the depth of the longitudinal grooves or ridges is decreasing towards a first and/or second longitudinal outer edge of the housing.

15. The razor cartridge according to claim 12, wherein the guard bar is made of a soft rubber material having shore hardness of 1 to 70 A.

16. The razor cartridge according to claim 2, wherein one of the first and second bars is designed as a comb-like bar, or both first and second bars are designed as comb-like bars.

17. The razor cartridge according to claim 16, wherein the comb-like bar comprises a plurality of transverse grooves or ridges, with a depth of 0.1 to 5 mm.

18. The razor cartridge according to claim 16, wherein the comb-like bar has an outer contour that is decreasing towards the first and/or second longitudinal outer edge of the housing.

19. The razor cartridge according to claim 16, wherein the comb-like bar is made of a hard plastic material having shore hardness of 40 to 99 A.

20. A razor, comprising:
a razor handle, and
a razor cartridge according to claim 1, wherein the razor cartridge is coupled to the razor handle.
